(19) United States
(12) Patent Application Publication
(10) Pub. No.: US 2010/0185551 A1
(43) Pub. Date: Jul. 22, 2010

(54) Web-based method for automating recruiting processes comprising job description generation, screening questionnaire generation, Boolean logic generation, screening applicants using knock-out, non-knock-out and essay questions, allowing employers to score and rank candidates, and allowing employers to re-calibrate the scores and rankings of applicants

(76) Inventors: Steve S. Ganesh, Castro Valley, CA (US); Lingling Li, San Ramon, CA (US)

Correspondence Address: STEVE S. GANESH, 25390 GOLD HILLS DRIVE, CASTRO VALLEY, CA, 94552, US

(21) Appl. No.: 12/691,730

(22) Filed: Jan. 21, 2010

Related U.S. Application Data
(60) Provisional application No. 61/146,069, filed on Jan. 21, 2009.

(51) Int. Cl. G06Q 10/00; G06F 17/30

(52) U.S. Cl. 705/321; 707/802; 707/E17.044

(57) ABSTRACT

The invention removes much of the labor previously associated with recruiting employees. Specifically the invention automates processes comprising compilation of strings of terms used in resume searches, writing of job descriptions, advertising and posting of job descriptions on Internet accessible job boards, sending e-mail invitations to apply to likely candidates, creation and administration of applicant screening questionnaires, scoring submitted questionnaires, re-calibration of scores based on changed criteria, and sending notification to employers about qualified candidates.

### CROSS-REFERENCE TO RELATED APPLICATION

This application claims the benefit of U.S. provisional application Ser. No. 61,146,069, filed Jan. 21, 2009.

### STATEMENT REGARDING FEDERALLY SPONSORED RESEARCH OR DEVELOPMENT

Not Applicable

### BACKGROUND OF INVENTION

Web based Job boards have been used for over 10 years and are very similar in how they function, whether for posting jobs or searching for resumes using keywords. In general, job boards provide two distinct functions. (1) They provide a means for companies who are looking for new hires to post descriptions of their open positions to which interested persons may apply by submitting their resumes, and in some cases also completing a screening questionnaire or employment application. And (2) they provide a collection of resumes submitted that are searchable by those looking for new hires, typically organized and searchable by keywords relating to job history and area of expertise.

There are processes that deal with disparate aspects of the recruiting process, such as materials, like resumes, received from job candidates, no system has yet been devised that incorporates all of the elements involved and which automates them. Most processes focus on a unique method of doing part of the work. For example the method and apparatus for storage and retrieval of resume images described in U.S. Patent Application No. 2007/0203918 A1 by Hartman et al., is concerned more with the preservation of original material(s) received from job candidates, but not at all with the processes of sourcing and screening of candidates.

A process for matching candidate resumes with job descriptions, such as that described in U.S. Pat. No. 6,385,620 B1 to Kurzius et al. (incorporated by reference), in which computer systems are used to automate matching candidates with open positions, is based on “keyword” matches.

### BRIEF SUMMARY OF THE INVENTION

The invention is a web-based recruiting service that enables employers to post jobs with the bare minimum of information, from which software processes automatically generate: search terms for conducting resume searches (Boolean strings), job descriptions (along with posting to on an online job board), screening questionnaires, and online Web pages for administering said screening questionnaires. The generated job description is the one that candidates will see when applying for the job; the screening questions generated are those that candidates will answer as part of the screening process; the generated Boolean strings are used to source candidates using the Internet and other sources. Once screening tests are submitted by candidates, the invention automatically computes test scores and sends notification(s) to employers by e-mail to employers that contain the resumes and screening results of high scoring candidates.

### BRIEF DESCRIPTION OF THE SEVERAL VIEWS OF THE DRAWING

FIGS. 1 and 2 show the initial user registration and job opening detail pages for job posters. The areas labeled with letters indicate fields for entering information used to job descriptions and screening questionnaires.

FIG. 2.1 (removed)

FIG. 2.2, titled “Job Description Wizard,” shows the first Web page of the wizard before any selection has taken place.

FIG. 2.3, titled “Job Description Wizard,” shows the Departments available via the pull-down menu (a).

FIG. 2.4, titled “Job Description Wizard,” shows the results in the Category field (b) of selecting a Department from (a).

FIG. 2.5, titled “Job Description Wizard,” shows the Title (c) pull-down field populated as a result of selecting a Category.

FIG. 2.6, titled “Job Description Wizard ,” shows the screening questions (b) available when the “Summary” radio button (a) is selected.

FIG. 2.7 titled “Job Description Wizard ,” shows the screening questions (b) that result from selecting the “Detailed” radio button (a).

FIG. 2.8 titled “Job Description Wizard ,” shows sample date entered into the fields provided for optional “required skills” (a), and “preferred skills” (b). The figure also points out the “Generate Job Desc” button (c) that the employer clicks to cause the questions to be added to an online form.

FIG. 2.9 titled “Installation,” shows the full text of a job skill available for inclusion in the generated job description.

FIG. 2.10, titled “Req Preview,” shows the complete text of the Wizard generated job description, with buttons for printing (a), or sending it via e-mail (b).

FIG. 2.11 titled “Copy Online Questions,” is a page from a Wizard for generating screening questions for advanced positions.

FIG. 2.12 titled “Online Questions” shows a feature of the invention for users to select among various types of question (a) to create from scratch.

FIG. 2.13 titled “Select Online Questions” shows the page for selecting the questions that will appear on an online screening.

FIG. 2.14 titled “Online Questions Setting” shows the page used for selecting the weight (a) and (c), or whether a single weighted question will be a “Knockout” question (b).

FIG. 2.15 titled “http://tekscreener.tekgriller.com/” is a dialog that warns the user that applicants have already answered screening questions and that therefore changing the weights of the screening questions will result in a recalculation of screening scores.

FIG. 2.16 titled “Req Screening Questions” shows the page for previewing screening questions before they are generated.

FIG. 2.17 titled “Online Screening Preview” shows a complete set of screening questions as they will appear to applicants.

FIG. 2.18, titled “Job Search,” shows the online job description with a link for applicants to apply online

FIG. 2.19, titled “Position: Oracle Apps DBA,” shows the first page an applicant sees when applying online

FIG. 2.20, titled “Confirm Screening,” shows a page used to allow applicants to attest that their efforts are their own alone.

FIG. 2.21, titled “Online Screening,” shows the first page of the online screening questionnaire.

FIG. 2.22, titled “HR Screening Questions,” shows a typical set of HR questions.

FIG. 2.23, titled “Thank you for completing the screening,” is the final page of the online screening process.

FIG. 3, titled “Req Preview,” is a typical job description. Information merged in from the forms (FIGS. 1 and 2) is indicated by labels.

FIG. 4, titled “Online Screening Preview,” is a typical screening questionnaire. Information merged in from forms (FIGS. 1 and 2) is indicated by labels.

FIG. 5.1, entitled “Sourced Req Overview,” is a form containing the information needed to search online for candidates for a job opening. Information that has been merged in (FIGS. 1 and 2) is indicated by the lettered labels. The field labeled “Search Strings,” FIG. 5.2 (a), contains a Boolean search string used in searching, or ‘sourcing’ on the Internet and/or other job boards. The notes in the field labeled “Notes to SO/A,” 5.2 (b), contain instructions for enhancing the automated sourcing with a.

FIG. 6 (removed)

FIG. 7, titled “TekScreener Login,” is the page allowing employers to access the system to administer open positions and review candidates' submitted materials, i.e., resumes, HR information, and answers to online screening questions.

FIG. 8, titled “Req List,” is the list of a client's positions, with relevant links labeled and described in detail in the Details of Invention section.

FIG. 9, titled “Job Summary,” is an encapsulated description for a job created by a client, specifically is shows the information entered by the client for the position.

FIG. 10, titled “Applicant Scores & Responses,” is a listing of the candidates who have submitted their resumes and answered the online screening questions. The relevant links have been labeled and are described in detain in the Details of Invention section.

### DETAILED DESCRIPTION OF THE INVENTION

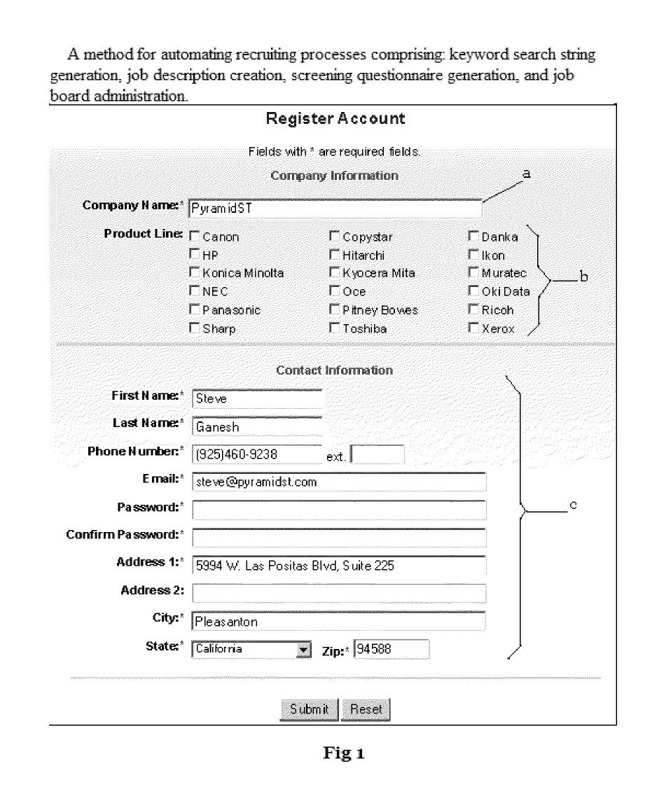

The first time a user subscribes, the user enters their basic company information (FIG. 1), comprising their company name, contact name, telephone number, email address, password, address, city, state and zip code. The company name is mapped to the job description (FIG. 1 and FIG. 5). The next time the user subscribes, they can log in using their email and password.

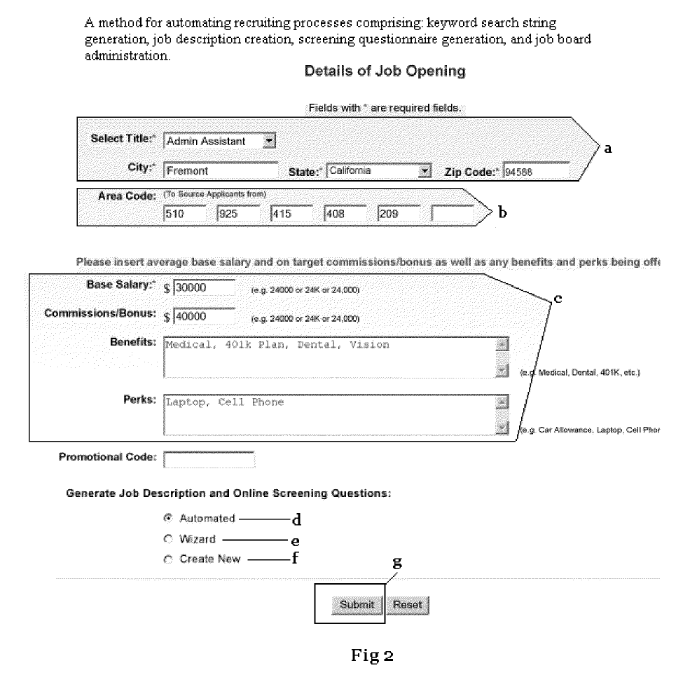

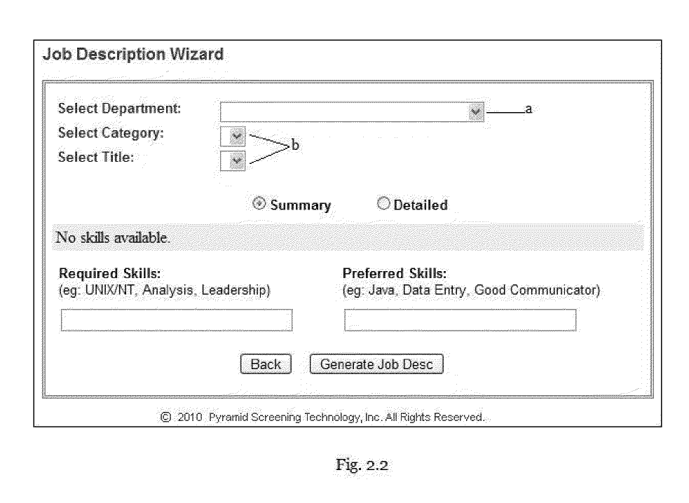

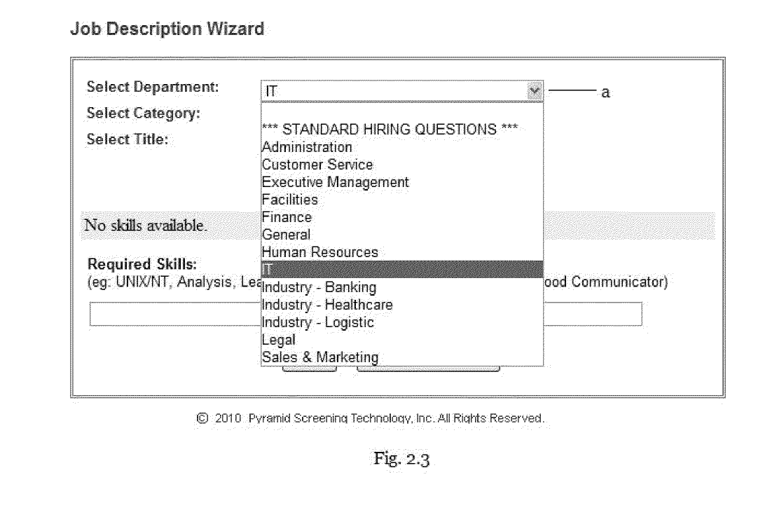

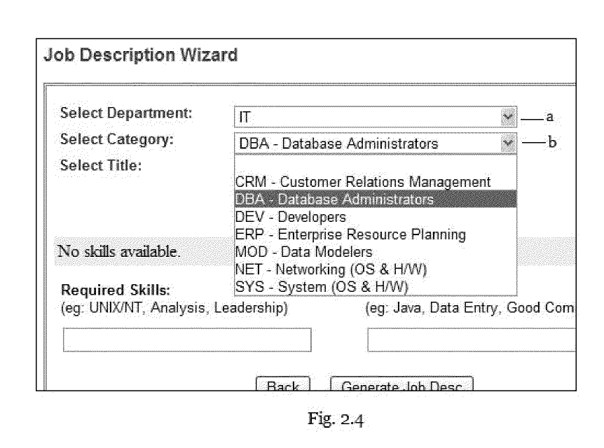

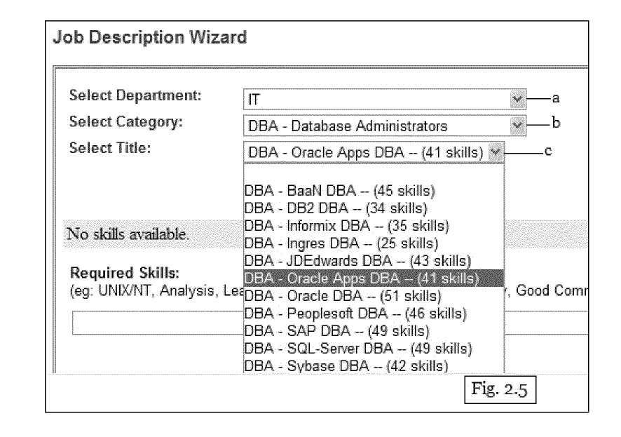

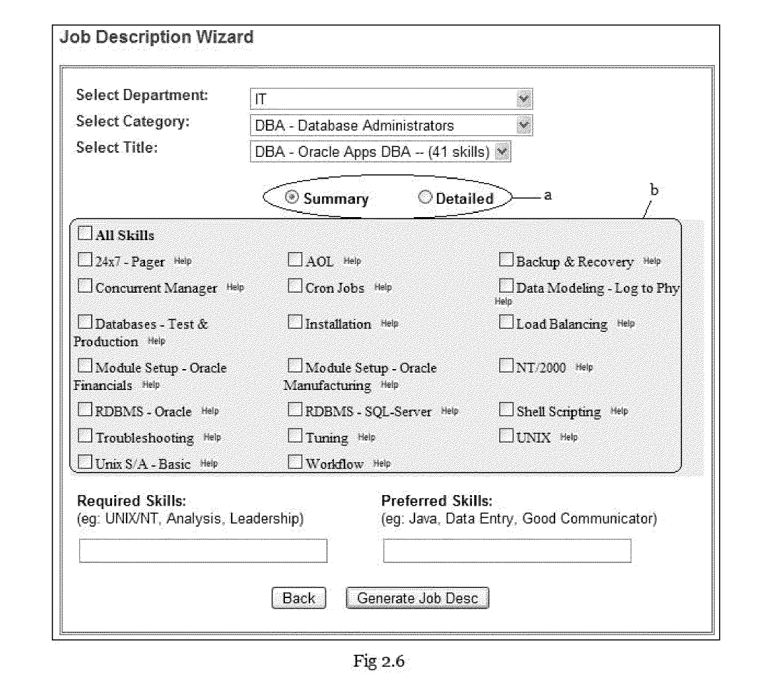

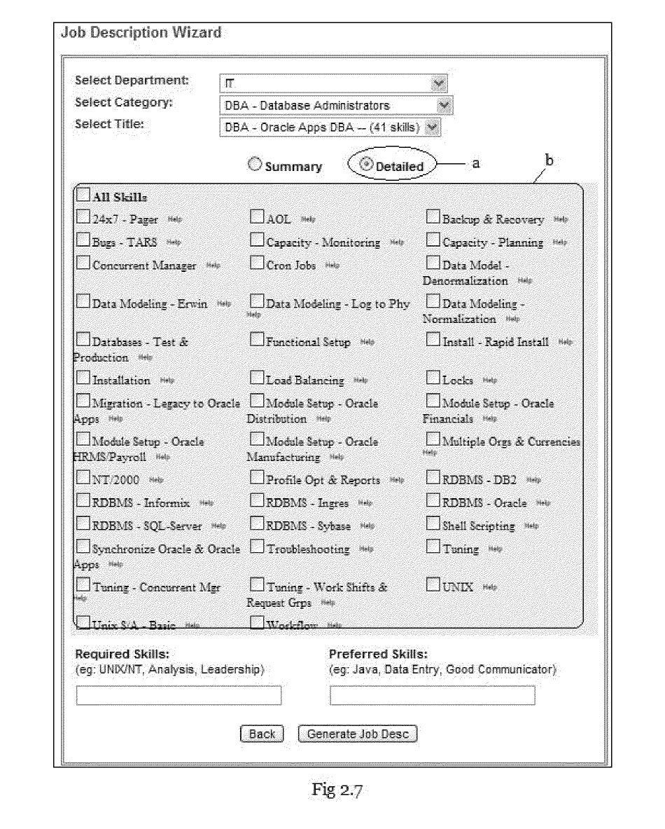

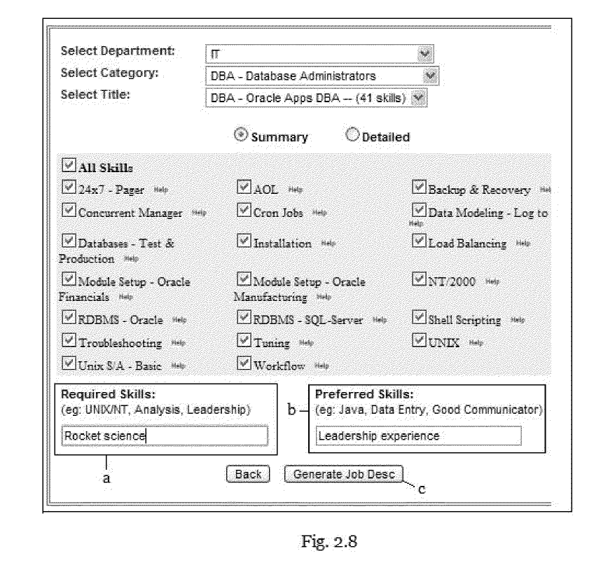

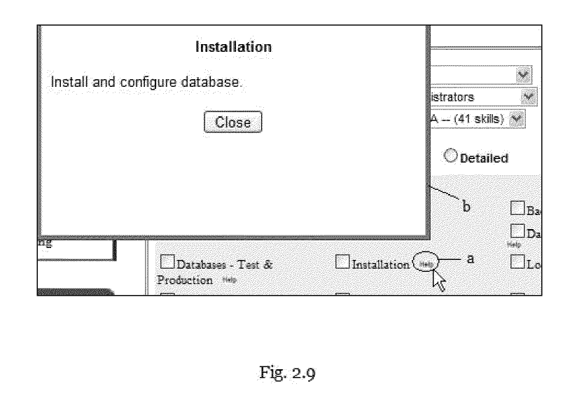

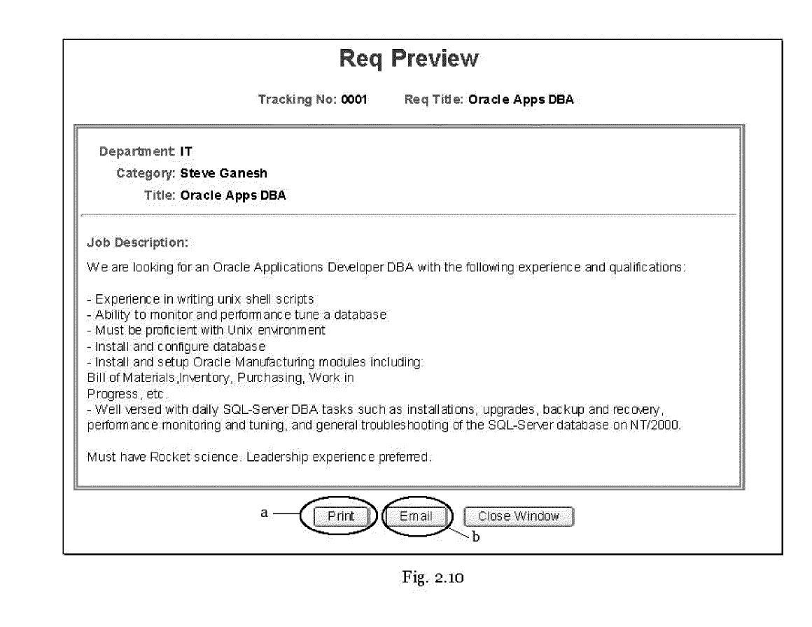

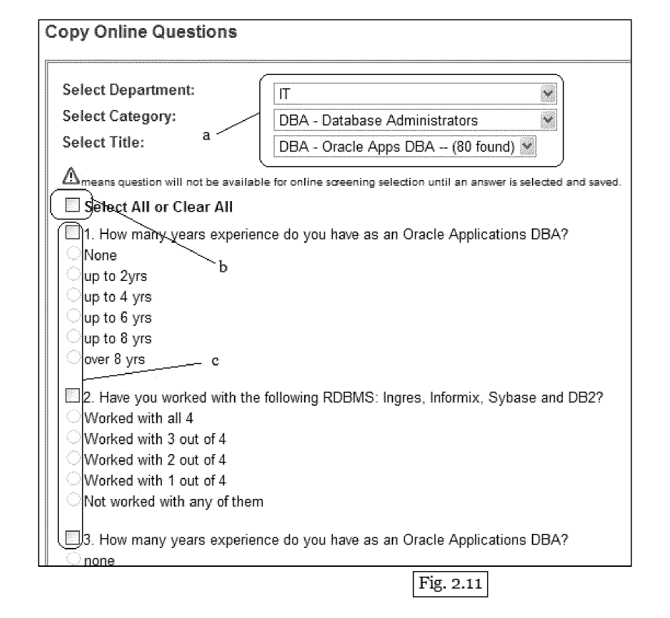

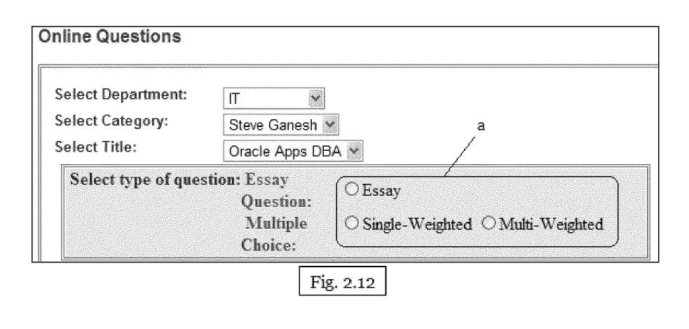

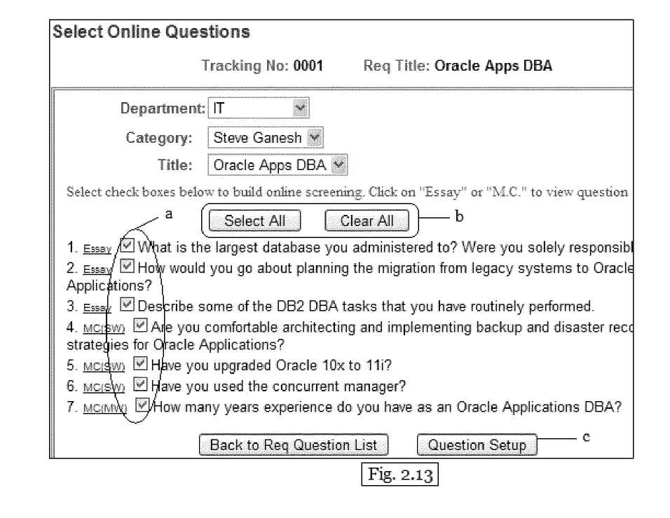

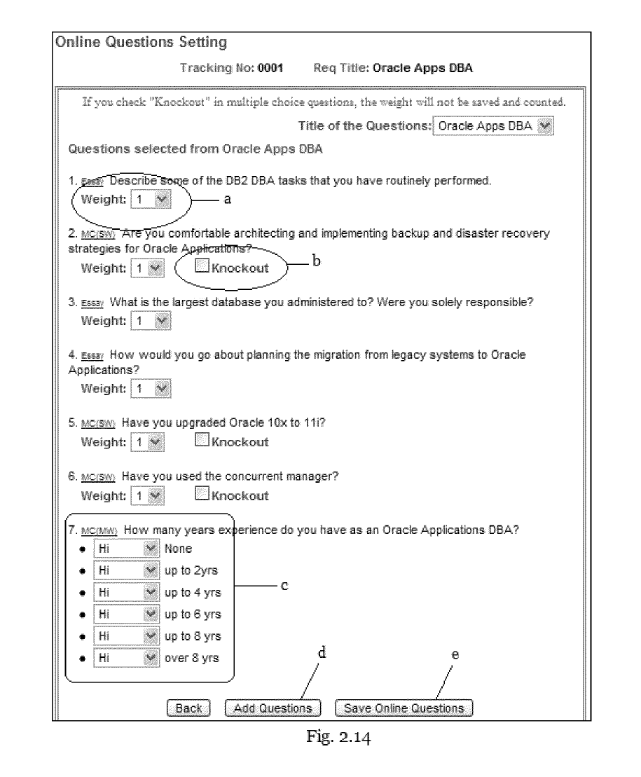

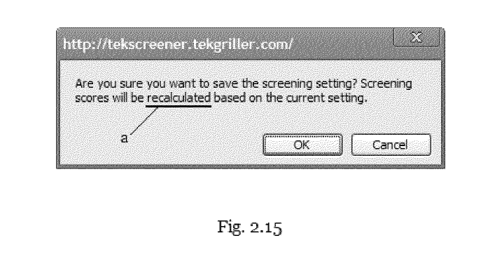

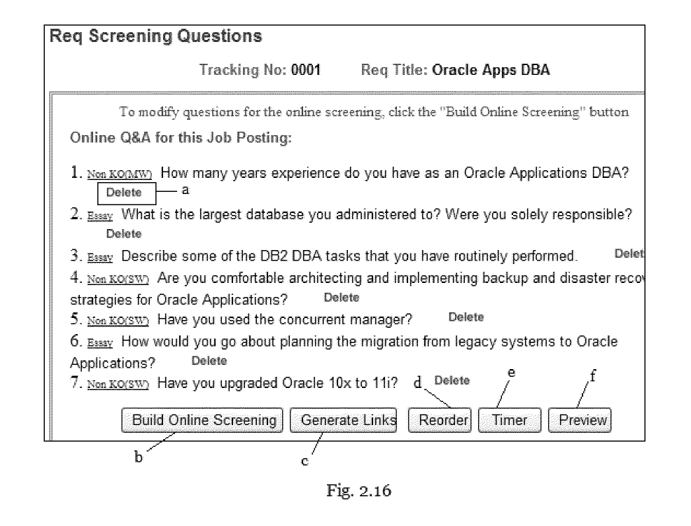

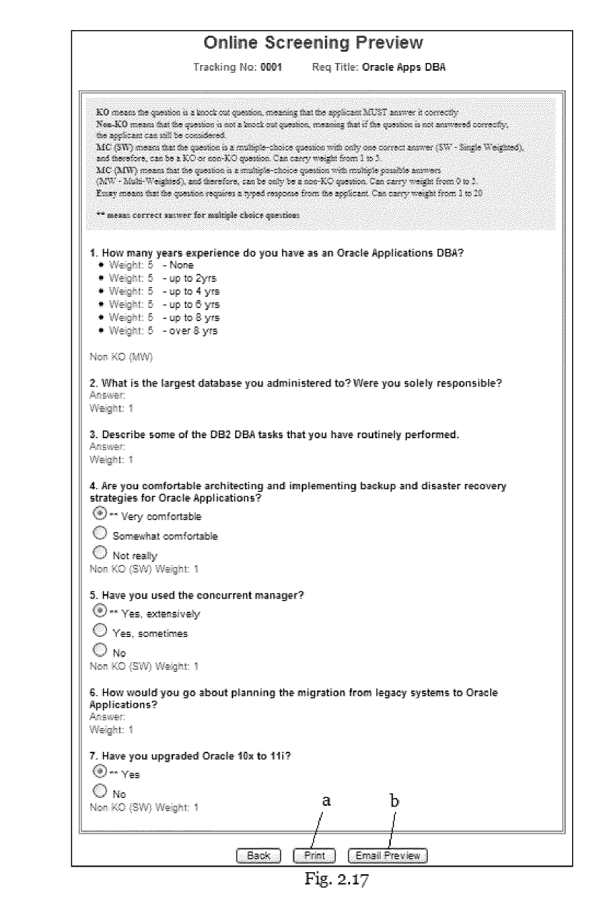

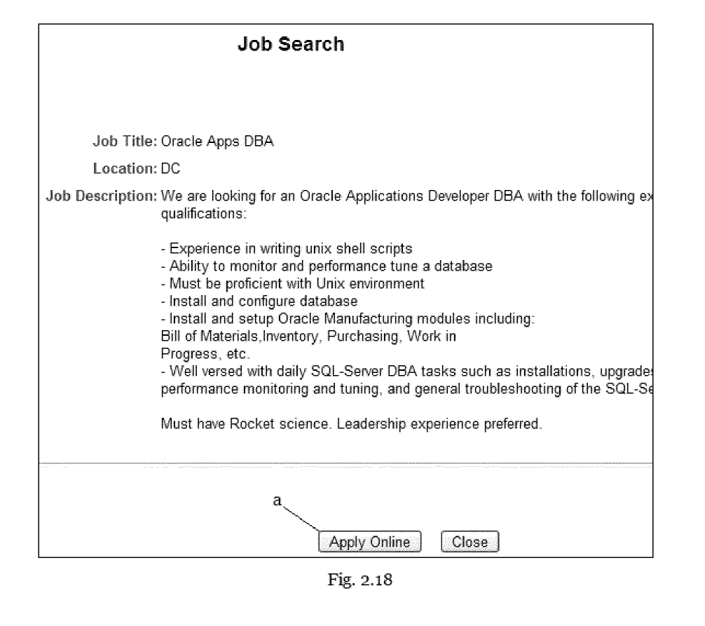

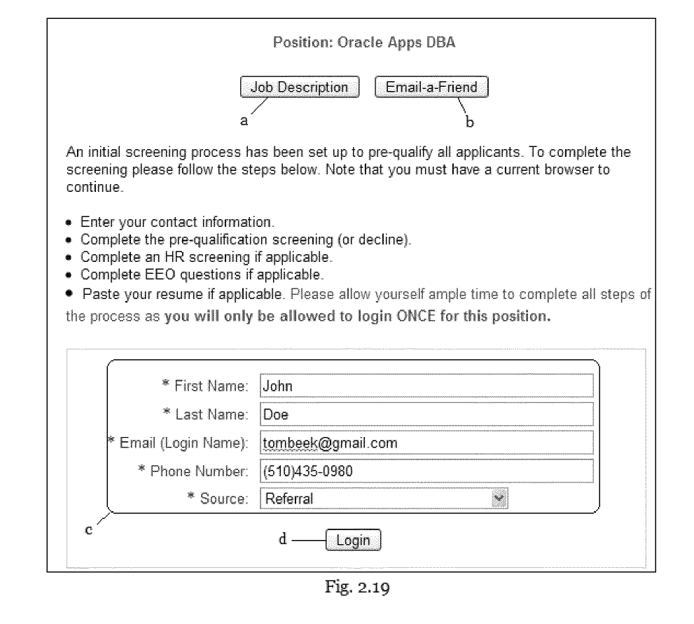

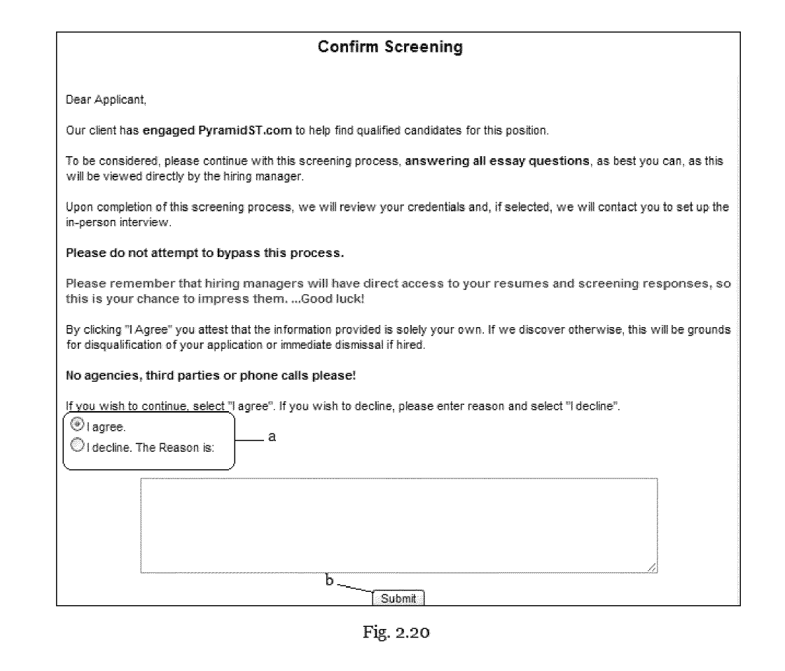

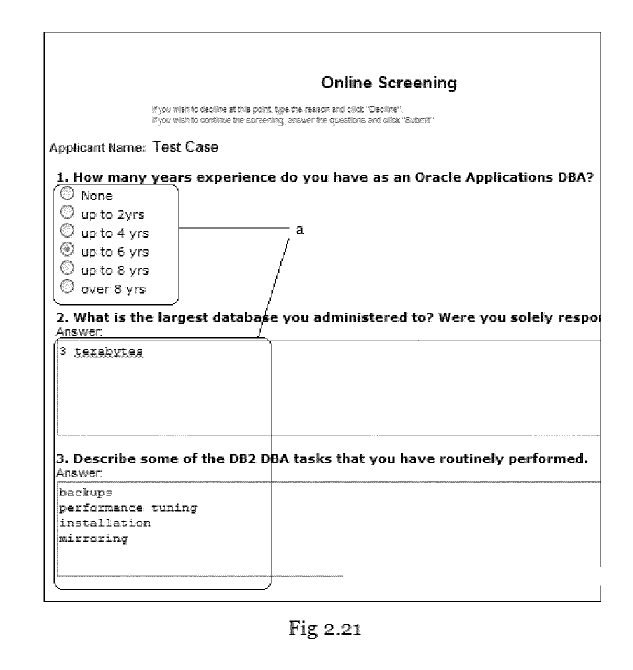

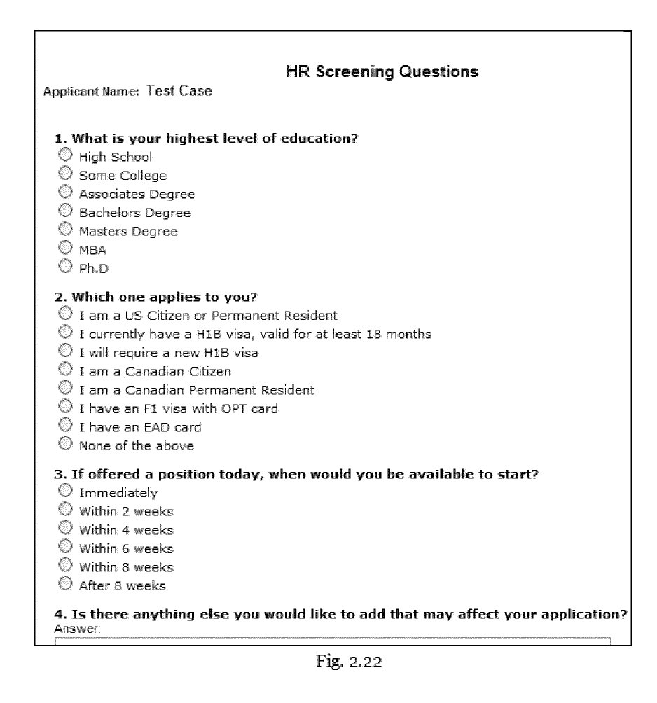

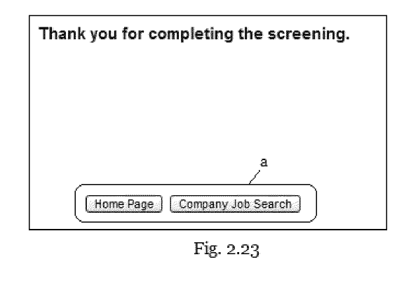

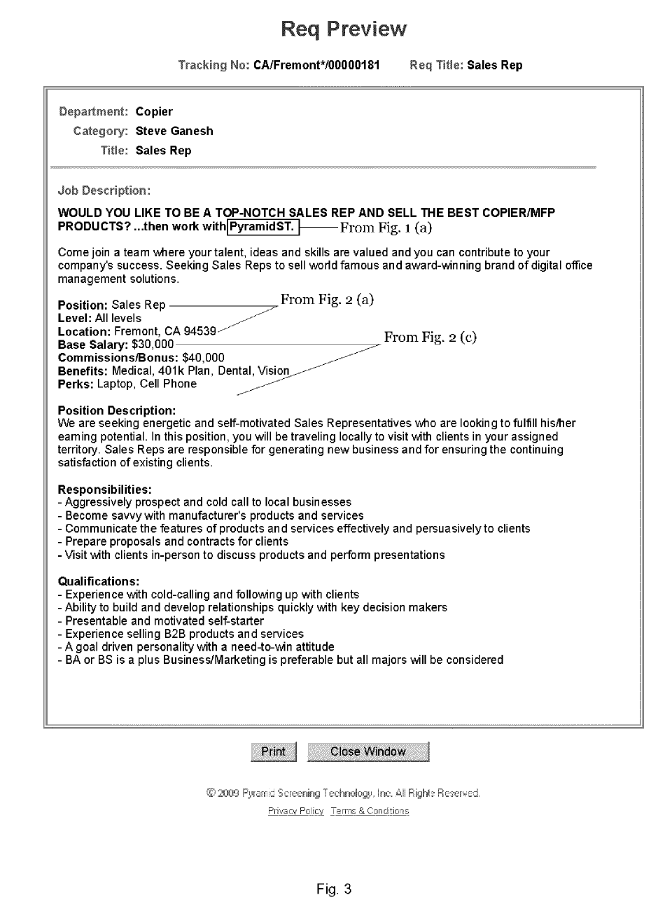

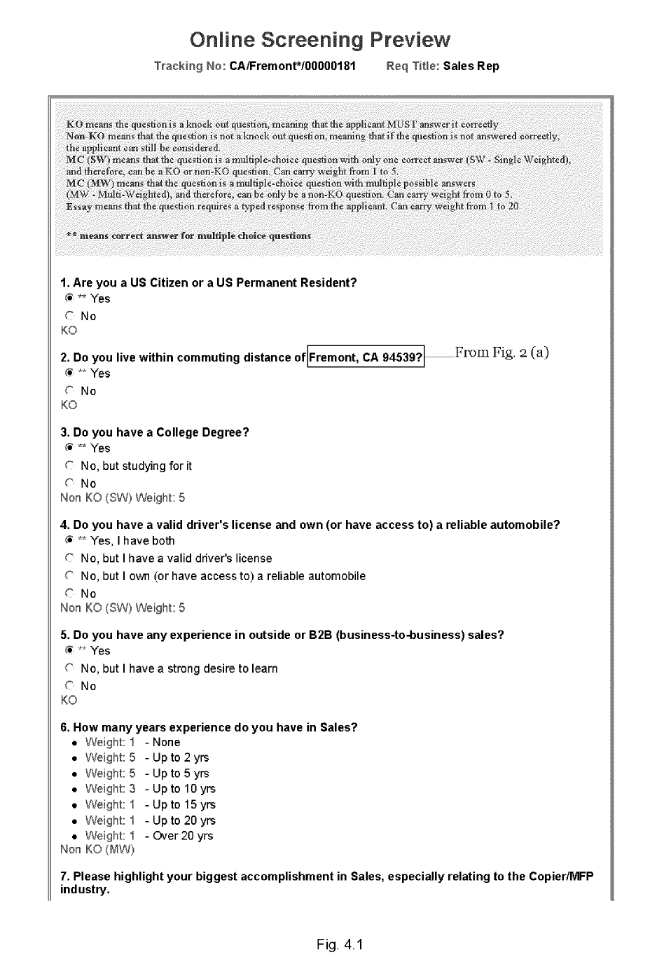

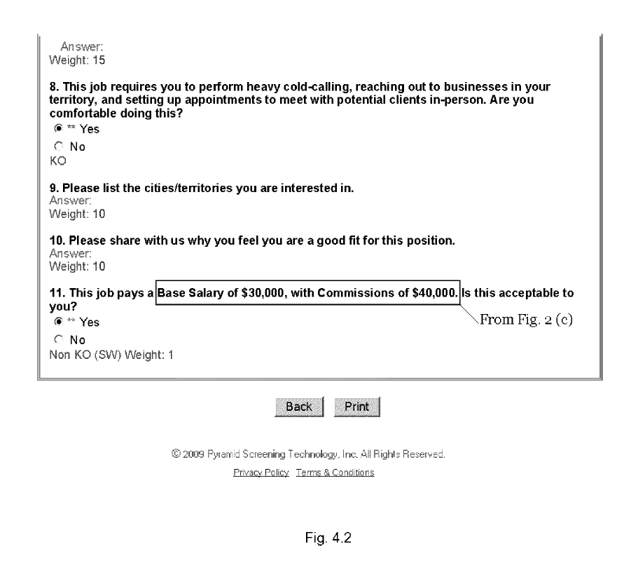

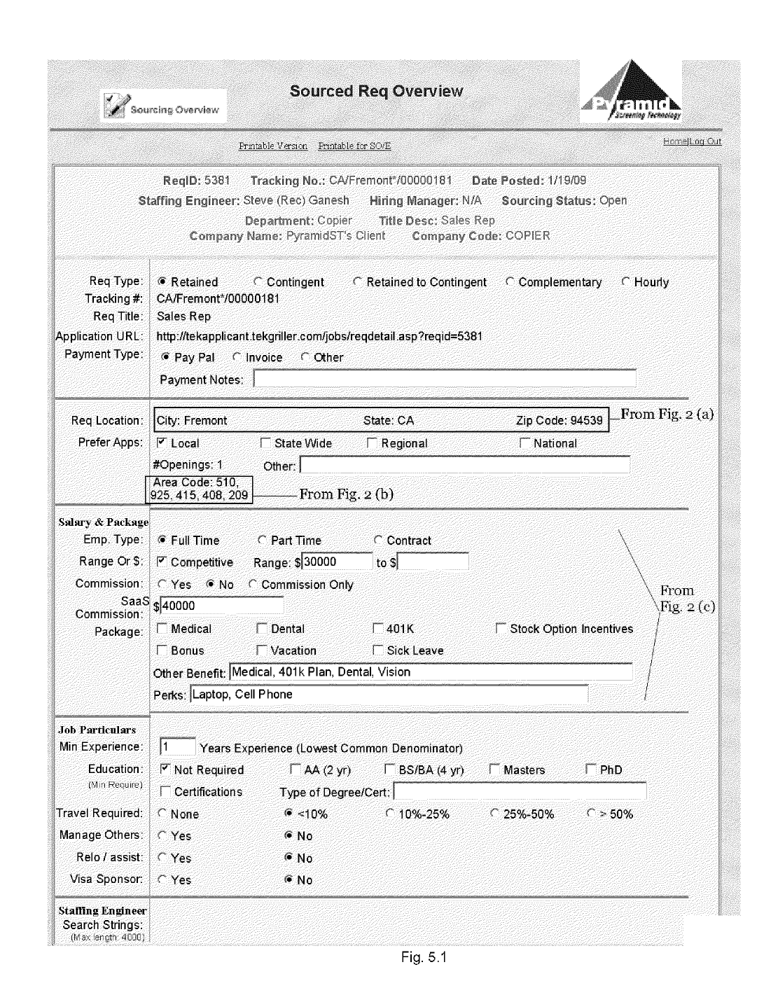

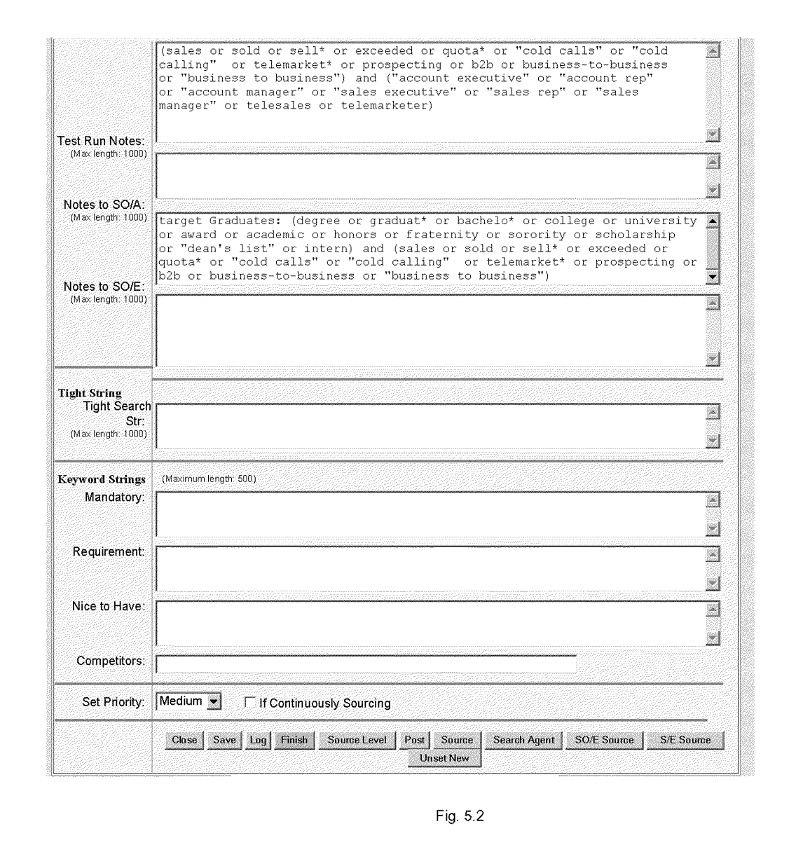

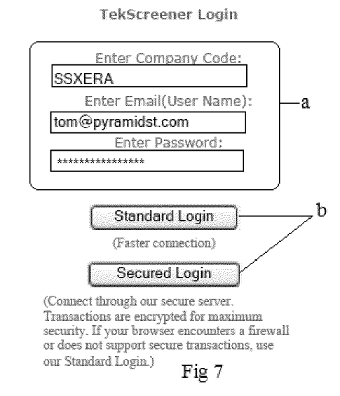

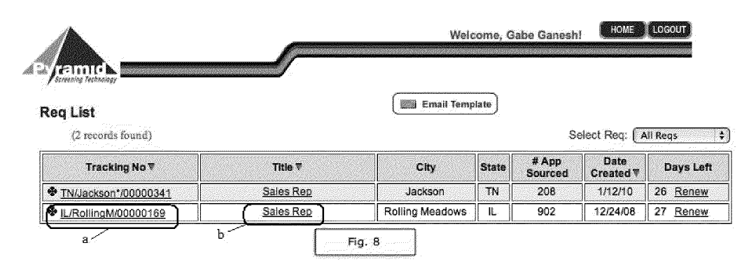

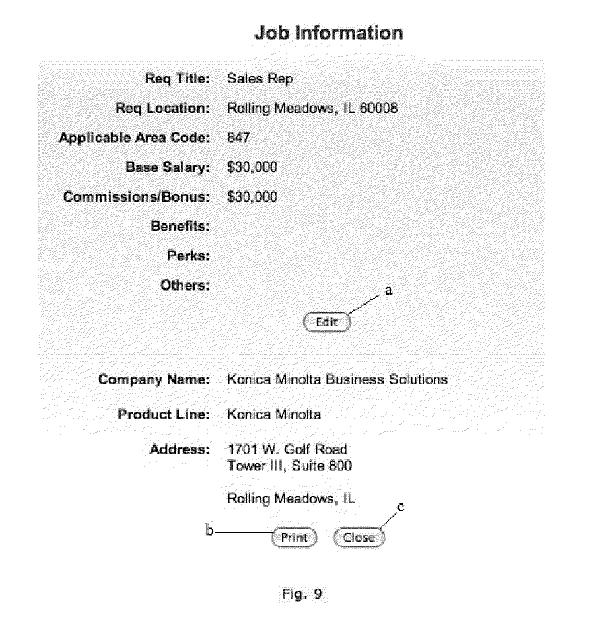

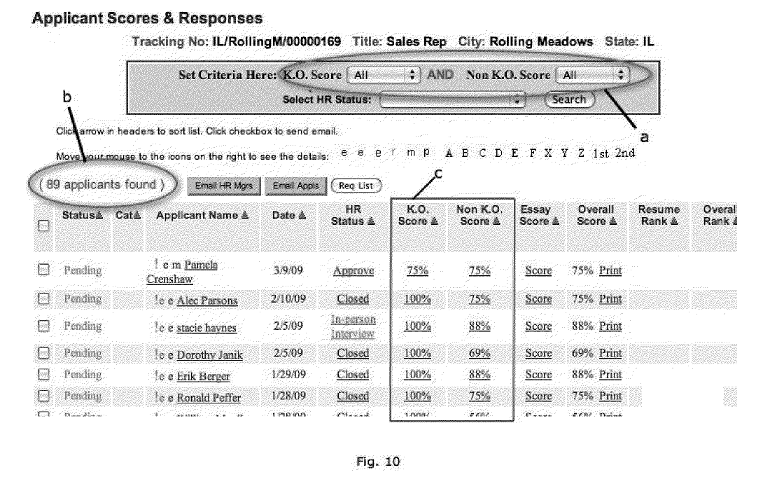

Once the user is ready to provide details of the job opening, the user selects a title, and inputs the following parameters for the position: City, State, Zip Code, Base Salary, Commissions/Bonus, Benefits and Perks (FIG. 2). From this information, a job description (FIG. 3), a set of screening questions (FIGS. 4.1 and 4.2) and a Boolean string (FIG. 5.2) will be generated. Though FIG. 2 represents the current parameters to be supplied by the user, other parameters may be added over time and incorporated into the job description, questionnaire and Boolean string.

Job seekers are sent emails automatically based on Boolean string matches to keywords in their resumes. Other job seekers will find the job description that has been posted automatically to one or more online job boards. There is a hyperlink pointing to a Web page for applying for the position contained in the body of email messages sent to candidates and on each Web page containing the job description.

Once a job seeker clicks on said hyperlink, he or she is directed to the page shown in FIG. 2.18, where they could click on the button (a) labeled “Apply Online” to access the screening questionnaire website and to submit their resume.

FIG. 2.19 shows the next page viewed by candidates, where they can access the job description again (a), send an e-mail to a friend with a hyperlink to the same page (b). Personal information needed to identify their application is entered in the area labeled (c), and clicking the button labeled “Login,” accepts their data and opens the confirmation page for the screening, FIG. 2.20, where they must click the radio button (a) labeled “I agree,” and the button (b) labeled “Submit.”

The next pages in the screening process is the Online Screening (FIG. 2.21), where applicants answer questions in various formats, such as multiple choice and essay questions (a). Applicants are then asked to reply to various standard HR questions, as shown in FIG. 2.22.

Upon completion of the screening applicants are directed to a Web page (FIG. 2.23) that informs them that the screening process is complete and presents links (a) for them to access other relevant Websites.

While the fully automated job descriptions and questionnaires suffice for positions such as truckers, bank tellers, and collection agents, employers can create job descriptions for more advanced positions using an aspect of the invention termed the “Job Description Wizard,” (FIG. 2.2).

Note that until a Department is selected in FIG. 2.2 (a), the Category and Title fields (b) are not populated. FIG. 2.3 (a) shows the list of departments in a pull-down menu.

Once a Department has been selected FIG. 2.4 (a), the Category field is populated with related information (b). And once a Category has been selected (FIG. 2.5), the Title field is populated with related positions, also showing how many screening questions are available for each position (c).

Once information has been chosen for fields (a), (b), and (c), the Wizard generates a set of required skills for the position, either in a smaller summary set (FIG. 2.6), or a larger, more detailed set (FIG. 2.7).

The Wizard provides two fields (FIG. 2.8) for optionally entering “required skills” (a), and “preferred skills” (b) to the job description. Clicking on “Help” link, shown in FIG. 2.9 (a), brings up a pop-up dialog box (b) containing the full text of the skill indicated.

When the user clicks the “Generate Job Desc” button (c), the selected skills are compiled into a job description. (FIG. 2.10). The resulting Web pages also has buttons to allow for printing (a) the description, or sending it by e-mail (b).

The invention also includes a wizard for generating screening questions for advanced positions. As shown in FIG. 2.11, is has a similar layout to the Job Description Wizard; it has job selection criteria at the top (a), and the ability to select all of the resulting questions at once (b), or individually (c).

If an employer wishes, the invention contains a facility for creating screening questions from scratch by selecting from among the varieties presented, FIG. 2.12 (a). Once a set of questions has been selected, FIG. 2.13, either individually (a), or selected/deselected in a group (b), the selected questions can be made part of an online screening template, and be made ready for weighting, by clicking (c) Question Setup.

The next step in generating questionnaires for advanced positions is to give a specific weight to the individual questions and to determine if the single weighted questions will be categorized as so called “Knockout” questions. FIG. 2.14 shows the page where these selections are made. The form shows essay questions (a), single weighted multiple choice questions that may be optionally designated as knockout questions (b), and multiple weighted multiple choice questions (c), in which a different weight may be assigned to each question.

If any applicants have already completed a particular screening questionnaire, making changes to the weight or designation of any questions will cause the screening scores to be recalculated. This is a powerful feature of the invention, but deserves caution, FIG. 2.15 (a).

A final preview is done with the page shown in FIG. 2.16, which includes the ability to delete questions (a), build the online screening (b), generate hyperlinks to the online screening (c), reorder the questions on the form (d), set an optional timer for the screening (e) that forces applicants to complete the screening within the given amount of time, and (f) the ability to preview the complete set of questions on a webpage as they will appear to applicants, FIG. 2.17. This page allows for the printing (a) and emailing (b) of the questions for review.

The invention claimed is:

1. An automated recruiting solution comprised of:
an automated job board; which feeds into
an automated/manual sourcing system; which feeds into
an automated screening system; and
a method for automatic e-mailing of qualified resumes; and/or
a Web-based portal for review, scoring, ranking, and tracking of candidates.

2. An automated job board which allows employers to place job orders online via one of the following methods:
a) selecting among pre-defined job titles, which generates a job description, screening questions, and a Boolean search string;
b) selecting among pre-defined job titles, and subsequently selecting various job elements from a list of relevant skills, each of which generates a line of text in a job description, a matching screening questionnaire, and Boolean search string;
c) input of a job description supplied by the employer, and using company to create questionnaire, screening questions, and Boolean string.

3. The method of claim 2, wherein said method further comprises the generation of a URL link to online versions of the job description and screening questionnaire.

4. A computer implemented system for screening job candidates based on ranked responses to job related questionnaires completed online.

5. The method of claim 4 wherein said ranked responses are stored in a computer database system and are viewable by the client via an Web page and/or received by e-mail.

6. The method of claim 4 wherein a score is generated for each questionnaire based on applicant's responses to questions, each of which has an assigned weight.

7. The method of claim 4 wherein said assigned weight of questions can be changed, in turn affecting the candidates' scores.

8. The method of claim 4 wherein said list of candidates viewable on a Web page can be filtered by means of software, such that only candidates who match certain criteria are visible in the listing, such criteria being comprised of compiled score for questions that form a basis for immediate rejection of the application, so-called KO questions;
a) compiled score for questions that do not immediately disqualify an application;
b) compiled score for essay questions optionally awarded by employer

9. The method of claim 4 combined with a system for ranking individual applications based on other factors, such as key words in candidates' resumes, responses to legal questions, or other factors.

10. The method of claim 4 wherein the system also includes a facility for storing text comments on individual candidates.

11. The method of claim 4 wherein the system also includes a facility for averaging the scores of several rankings by various members of an employment team for an applicant.

12. The method of claim 4 wherein the system also includes a facility for generating reports, for example, EEO, progress, sourcing, time to fill, time to act, and unfilled positions.
